(19) United States
(12) Patent Application Publication
(10) Pub. No.: US 2023/0230205 A1
(43) Pub. Date: Jul. 20, 2023

(54) IMAGE ENHANCEMENT METHOD AND APPARATUS, ELECTRONIC DEVICE, AND STORAGE MEDIUM

(71) Applicant: Beijing Baidu Netcom Science Technology Co., Ltd., BEIJING (CN)

(72) Inventors: Xin Li, Beijing (CN); Dongliang He, Beijing (CN); Qi Zhang, Beijing (CN)

(21) Appl. No.: 18/155,901

(22) Filed: Jan. 18, 2023

(30) Foreign Application Priority Data
Jan. 19, 2022 (CN) 202210060864.7

(51) Int. Cl. G06T 5/00; G06T 3/40

(52) U.S. Cl. CPC G06T 5/001; G06T 3/40; G06T 2207/20081; G06T 2207/20084; G06T 2207/20016; G06T 2207/10024

(57) ABSTRACT

Provided are an image enhancement method and apparatus, an electronic device, and a storage medium. The image enhancement method includes: acquiring an original image, and configuring the original image as a current image; selecting a renderer from a plurality of pre-trained renderers as a current renderer in response to the current image satisfying a preset enhancement condition; and inputting the current image to the current renderer, and outputting, through the current renderer, an enhanced image of the current image in a dimension corresponding to the current renderer; and repeating the preceding operation by configuring the enhanced image of the current image in the dimension corresponding to the current renderer as the current image until the current image does not satisfy the enhancement condition.

### CROSS-REFERENCE TO RELATED APPLICATION(S)

This application claims priority to Chinese Patent Application No. 202210060864.7 filed Jan. 19, 2022, the disclosure of which is incorporated herein by reference in its entirety.

### TECHNICAL FIELD

The present disclosure relates to the technical field of artificial intelligence, further relates to computer vision and deep learning technology, and in particular relates to an image enhancement method and apparatus, an electronic device, and a storage medium.

### BACKGROUND

Generally, when photos are taken or videos recorded, the captured photos or recorded videos often have problems such as overexposure/underexposure and insufficiently bright colors due to light rays, capture devices, or the like. At present, there are mainly the following two methods for solving the problem that image/video colors are not good: (1) a colorist manually adjusts the colors in a later stage with more commonly used software such as Photoshop and Lightroom but the disadvantages of manually adjusting the colors are distinct: it is time-consuming and labor-intensive, the results of the adjustment are limited by the level of the colorist, and it is very difficult to quickly adjust the colors in large batches and obtain satisfactory results; (2) at present, some algorithms can perform brightness enhancement on low-light images, tone enhancement, or saturation enhancement, but it is very difficult for these algorithms to perform adaptive image enhancement in multiple dimensions on a large scale, for example, few algorithms can process dark images in multiple dimensions, and the existing algorithms can only solve problems in a particular scenario.

### SUMMARY

The present disclosure provides an image enhancement method and apparatus, an electronic device, and a storage medium.

In a first aspect, the present application provides an image enhancement method, and the method includes the steps described below.

An original image is acquired, and the original image is configured as a current image.

A renderer is selected from multiple pre-trained renderers as a current renderer in response to the current image satisfying a preset enhancement condition.

The current image is input to the current renderer, and an enhanced image of the current image in a dimension corresponding to the current renderer is output through the current renderer; and the preceding operation is repeated by configuring the enhanced image of the current image in the dimension corresponding to the current renderer as the current image until the current image does not satisfy the enhancement condition.

In a second aspect, the present application provides an image enhancement apparatus, and the apparatus includes an acquisition module, a selection module, and an enhancement module.

The acquisition module is configured to acquire an original image and configure the original image as a current image.

The selection module is configured to select a renderer from multiple pre-trained renderers as a current renderer in response to the current image satisfying a preset enhancement condition.

The enhancement module is configured to: input the current image to the current renderer and output, through the current renderer, an enhanced image of the current image in a dimension corresponding to the current renderer; and repeat the preceding operation by configuring the enhanced image of the current image in the dimension corresponding to the current renderer as the current image until the current image does not satisfy the enhancement condition.

In a third aspect, an embodiment of the present application provides an electronic device.

The electronic device includes one or more processors and a memory.

The memory is configured to store one or more programs.

When executed by the one or more processors, the one or more programs cause the one or more processors to implement the image enhancement method according to any embodiment of the present application.

In a fourth aspect, an embodiment of the present application provides a storage medium storing a computer program that, when executed by a processor, implements the image enhancement method according to any embodiment of the present application.

In a fifth aspect, a computer program product is provided. When executed by a computer device, the computer program product implements the image enhancement method according to any embodiment of the present application.

According to the technology of the present application, the technical problems are solved that in the related art, manually adjusting colors is time-consuming and labor-intensive, the results of the adjustment are limited by the level of a colorist, and it is very difficult to quickly adjust the colors in large batches and obtain satisfactory results; and it is very difficult for existing algorithms to perform an adaptive adjustment in multiple dimensions on a large scale, and the existing algorithms are only adaptable to a particular scenario. With the technical solution provided by the present application, an image can be adaptively enhanced in the multiple dimensions on a large scale, which is time-saving and labor-saving, strongly effective, and applicable to various application scenarios.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a first flowchart of an image enhancement method according to an embodiment of the present application;

FIG. 2 is a second flowchart of an image enhancement method according to an embodiment of the present application;

FIG. 3 is a structural diagram of a prediction network according to an embodiment of the present application;

FIG. 4 is a structural diagram of a rendering network according to an embodiment of the present application;

FIG. 5 is a third flowchart of an image enhancement method according to an embodiment of the present application;

FIG. 6 is a structural diagram of an image enhancement apparatus according to an embodiment of the present application; and

FIG. 7 is a block diagram of an electronic device for implementing an image enhancement method according to an embodiment of the present application.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

### Embodiment One

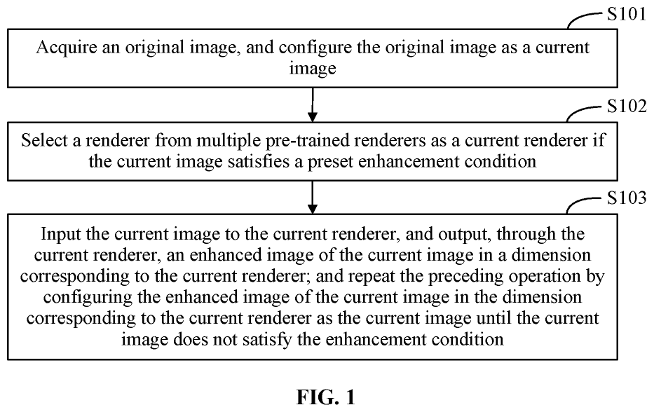

FIG. 1 is a first flowchart of an image enhancement method according to an embodiment of the present application. The method may be executed by an image enhancement apparatus or an electronic device. The apparatus or the electronic device may be implemented as software and/or hardware. The apparatus or the electronic device may be integrated in any intelligent device having a network communication function. As shown in FIG. 1, the image enhancement method may include the steps described below.

In S101, an original image is acquired, and the original image is configured as a current image.

In this step, the electronic device may acquire the original image and then configure the original image as the current image. The image in the embodiment of the present application may be a photo or a frame in a video.

In S102, in a case where the current image satisfies a preset enhancement condition, a renderer is selected from multiple pre-trained renderers as a current renderer.

In this step, if the current image satisfies the preset enhancement condition, the electronic device may select the renderer from the multiple pre-trained renderers as the current renderer. The renderer in the embodiment of the present application may include, but is not limited to, an exposure renderer, a tone renderer, and a saturation renderer. Therefore, the preceding three renderers need to be trained first. Using the exposure renderer as an example, first, a batch of images with good colors are adjusted to different values according to three dimensions through Lightroom, and then, the corresponding images are saved. For example, an image I with good colors is rendered according to different dimensions through the software so that image data is generated, and positive and negative 50 images are generated for each dimension. Using exposure as an example, assuming that an exposure range is (−100, 100), images having an exposure of −100, −98, −96, . . . , 96, 98, 100 are separately generated with a step size of 2. The generated images are configured as outputs, the original image is configured as an input, and the adjusted exposures are configured as input parameters such that the exposure renderer can be trained.

In S103, the current image is input to the current renderer, and an enhanced image of the current image in a dimension corresponding to the current renderer is output through the current renderer; and the preceding operation is repeated by configuring the enhanced image of the current image in the dimension corresponding to the current renderer as the current image until the current image does not satisfy the enhancement condition.

In this step, the electronic device may input the current image to the current renderer and output, through the current renderer, the enhanced image of the current image in the dimension corresponding to the current renderer; and repeat the preceding operation by configuring the enhanced image of the current image in the dimension corresponding to the current renderer as the current image until the current image does not satisfy the enhancement condition. Specifically, the electronic device may input the current image to a first network and a second network in the current renderer; obtain, based on the current image through the first network, a rendering value corresponding to the current image in the current renderer; and transmit the rendering value to the second network and render the current image based on the rendering value through the second network so that the enhanced image of the current image in the dimension corresponding to the current renderer is obtained. In the embodiment of the present application, the first network may be a prediction network (e.g. an operator module), and the second network may be a render network. Optionally, the prediction network can be shared in multiple different renderers. According to the image enhancement method provided by the embodiment of the present application, the original image is acquired, and the original image is configured as the current image; if the current image satisfies the preset enhancement condition, the renderer is selected from the multiple pre-trained renderers as the current renderer; the current image is input to the current renderer, and the enhanced image of the current image in the dimension corresponding to the current renderer is output through the current renderer; and the preceding operation is repeated by configuring the enhanced image of the current image in the dimension corresponding to the current renderer as the current image until the current image does not satisfy the enhancement condition. That is, according to the present application, the renderer can be adaptively selected from the multiple renderers, and with the renderer, the current image is rendered in the dimension corresponding to the renderer. With existing image enhancement methods such as a manual adjustment by a colorist in a later stage or some algorithms, the image can be enhanced only in a respective dimension and cannot be processed in multiple dimensions. According to the technical means of the present application, the multiple renderers are trained in advance and the current image is enhanced through the multiple renderers one by one. Therefore, the technical problems are overcome that in the related art, manually adjusting colors is time-consuming and labor-intensive, the results of the adjustment are limited by the level of the colorist, and it is very difficult to quickly adjust the colors in large batches and obtain satisfactory results; and it is very difficult for existing algorithms to perform an adaptive adjustment in the multiple dimensions on a large scale, and the existing algorithms are only adaptable to a particular scenario. With the technical solution provided by the present application, the image can be adaptively enhanced in the multiple dimensions on a large scale, which is time-saving and labor-saving, strongly effective, and applicable to various application scenarios. Moreover, the technical solution of the embodiment of the present application is simple and convenient to implement, easy to popularize, and applicable to a wider range.

### Embodiment Two

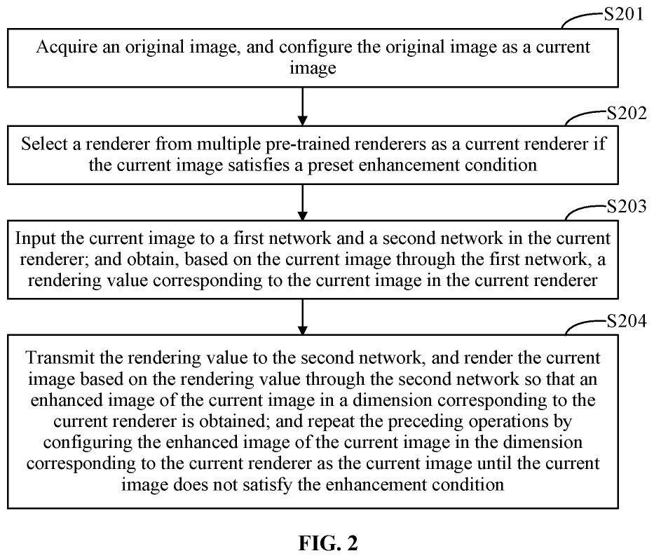

FIG. 2 is a second flowchart of an image enhancement method according to an embodiment of the present application. This embodiment is an optimization and expansion of the preceding technical solution and can be combined with each preceding optional embodiment. As shown in FIG. 2, the image enhancement method may include the steps described below.

In S201, an original image is acquired, and the original image is configured as a current image.

In S202, in a case where the current image satisfies a preset enhancement condition, a renderer is selected from multiple pre-trained renderers as a current renderer.

In S203, the current image is input to a first network and a second network in the current renderer; and a rendering value corresponding to the current image in the current renderer is obtained based on the current image through the first network.

In this step, the electronic device may input the current image to the first network and the second network in the current renderer; and obtain, based on the current image through the first network, the rendering value corresponding to the current image in the current renderer. Specifically, the electronic device may input the current image to a convolutional neural network (CNN) and perform feature extraction on the current image through the CNN so that a feature map corresponding to the current image is obtained; then calculate a mean, a variance, and a maximum value of the feature map on each path; and predict, based on the mean, the variance, and the maximum value of the feature map on each path, the rendering value corresponding to the current image in the current renderer. To increase a speed, in the present application, the current image may be downsampled, and the feature extraction is performed on the downsampled image through the CNN. The mean, the variance, and the maximum value of the feature map on each path are calculated and concatenated into a new feature. The rendering value of the current renderer is predicted through a fully connected layer according to the new feature, and the current image is rendered with this rendering value so that a new image is obtained. After three basic operations, colors of a degraded image can be improved.

In S204, the rendering value is transmitted to the second network, and the current image is rendered based on the rendering value through the second network so that the enhanced image of the current image in the dimension corresponding to the current renderer is obtained; and the preceding operations are repeated by configuring the enhanced image of the current image in the dimension corresponding to the current renderer as the current image until the current image does not satisfy the enhancement condition.

In this step, the electronic device may transmit the rendering value to the second network and render the current image based on the rendering value through the second network so that the enhanced image of the current image in the dimension corresponding to the current renderer is obtained; and repeat the preceding operations by configuring the enhanced image of the current image in the dimension corresponding to the current renderer as the current image until the current image does not satisfy the enhancement condition. Specifically, the electronic device may input the current image to a first rendering unit in the second network so that a rendering result output by the first rendering unit is obtained; and input the rendering result output by the first rendering unit and the rendering value to a second rendering unit in the second network so that a rendering result output by the second rendering unit is obtained and configure the rendering result output by the second rendering unit as the enhanced image of the current image in the dimension corresponding to the current renderer; where the first rendering unit includes two fully connected layers and one activation function; and the second rendering unit includes two fully connected layers and two activation functions.

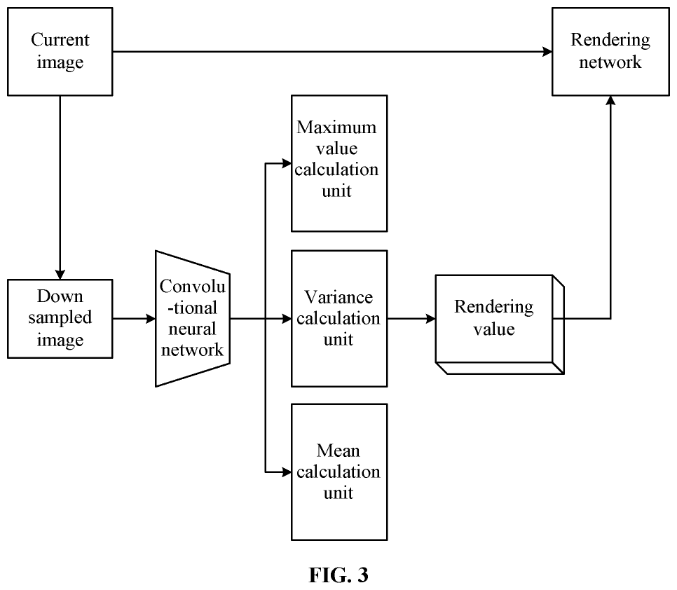

FIG. 3 is a structural diagram of the prediction network according to an embodiment of the present application. As shown in FIG. 3, the prediction network may include the convolutional neural network (e.g. a CNN feature extractor), a mean calculation unit (e.g. mean), a variance calculation unit (e.g. std), a maximum value calculation unit (e.g. max), a concatenation unit (e.g. concat), and the fully connected layer (FC). Specifically, the current image may be downsampled, and the feature extraction is performed on the sampled image through the CNN. The mean, the variance, and the maximum value of the feature map on each path are calculated and concatenated into the new feature. The rendering value of the current renderer is predicted through the fully connected layer according to the new feature, and the current image is rendered with this value so that the new image is obtained. After the three basic operations, the colors of the degraded image can be improved.

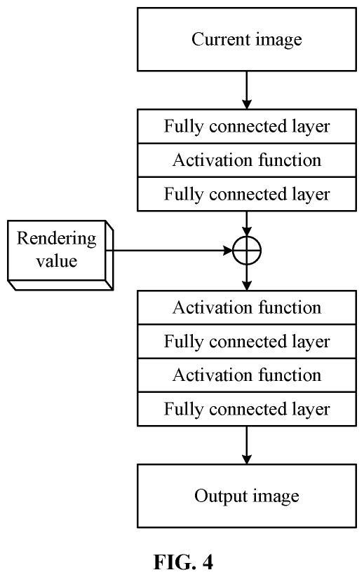

FIG. 4 is a structural diagram of the rendering network according to an embodiment of the present application. As shown in FIG. 4, the rendering network may include the first rendering unit and the second rendering unit, where the first rendering unit includes the two fully connected layers and the one activation function; and the second rendering unit includes the two fully connected layers and the two activation functions. Specifically, the structure of the first rendering unit includes a fully connected layer (FC), an activation function (e.g. Leaky ReLU), and a fully connected layer (FC); and the structure of the second rendering unit includes an activation function (e.g. Leaky ReLU), a fully connected layer (FC), an activation function (e.g. Leaky ReLU), and a fully connected layer (FC).

According to the image enhancement method provided by the embodiment of the present application, the original image is acquired, and the original image is configured as the current image; if the current image satisfies the preset enhancement condition, the renderer is selected from the multiple pre-trained renderers as the current renderer; the current image is input to the current renderer, and the enhanced image of the current image in the dimension corresponding to the current renderer is output through the current renderer; and the preceding operation is repeated by configuring the enhanced image of the current image in the dimension corresponding to the current renderer as the current image until the current image does not satisfy the enhancement condition. That is, according to the present application, the renderer can be adaptively selected from the multiple renderers, and with the renderer, the current image is rendered in the dimension corresponding to the renderer. With existing image enhancement methods such as a manual adjustment by a colorist in a later stage or some algorithms, the image can be enhanced only in a respective dimension and cannot be processed in multiple dimensions. According to the technical means of the present application, the multiple renderers are trained in advance and the current image is enhanced through the multiple renderers one by one. Therefore, the technical problems are overcome that in the related art, manually adjusting colors is time-consuming and labor-intensive, the results of the adjustment are limited by the level of the colorist, and it is very difficult to quickly adjust the colors in large batches and obtain satisfactory results; and it is very difficult for existing algorithms to perform an adaptive adjustment in the multiple dimensions on a large scale, and the existing algorithms are only adaptable to a particular scenario. With the technical solution provided by the present application, the image can be adaptively enhanced in the multiple dimensions on a large scale, which is time-saving and labor-saving, strongly effective, and applicable to various application scenarios. Moreover, the technical solution of the embodiment of the present application is simple and convenient to implement, easy to popularize, and applicable to a wider range.

### Embodiment Three

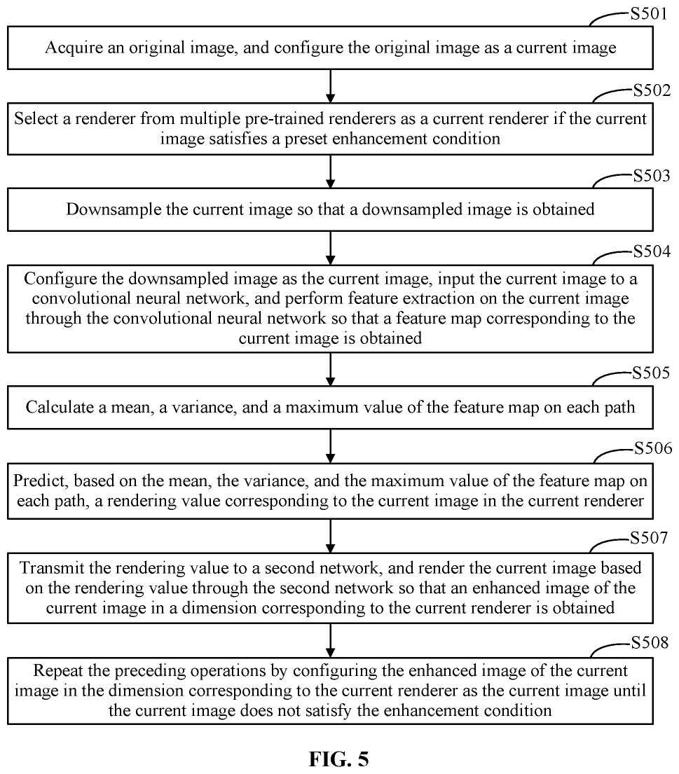

FIG. 5 is a third flowchart of an image enhancement method according to an embodiment of the present application. This embodiment is an optimization and expansion of the preceding technical solution and can be combined with each preceding optional embodiment. As shown in FIG. 5, the image enhancement method may include the steps described below.

In S501, an original image is acquired, and the original image is configured as a current image.

In S502, in a case where the current image satisfies a preset enhancement condition, a renderer is selected from multiple pre-trained renderers as a current renderer.

In S503, the current image is downsampled so that a downsampled image is obtained.

In this step, the electronic device may downsample the current image so that the downsampled image is obtained. For example, assuming that the current image is a 1024×1024 image, the current image is downsampled so that a 256×256 image may be obtained.

In S504, the downsampled image is configured as the current image, the current image is input to a CNN, and feature extraction is performed on the current image through the CNN so that a feature map corresponding to the current image is obtained.

In S505, a mean, a variance, and a maximum value of the feature map on each path are calculated.

In S506, a rendering value corresponding to the current image in the current renderer is predicted based on the mean, the variance, and the maximum value of the feature map on each path.

In S507, the rendering value is transmitted to a second network, and the current image is rendered based on the rendering value through the second network so that an enhanced image of the current image in a dimension corresponding to the current renderer is obtained.

In the embodiment of the present application, to increase a speed, the current image may be downsampled, and the feature extraction is performed on the downsampled image through the CNN. The mean, the variance, and the maximum value of the feature map on each path are calculated and concatenated into a new feature. The rendering value of the current renderer is predicted through a fully connected layer according to the new feature, and the current image is rendered with this value so that a new image is obtained. After three basic operations, colors of a degraded image can be improved.

In S508, the preceding operations are repeated by configuring the enhanced image of the current image in the dimension corresponding to the current renderer as the current image until the current image does not satisfy the enhancement condition.

According to the image enhancement method provided by the embodiment of the present application, the original image is acquired, and the original image is configured as the current image; if the current image satisfies the preset enhancement condition, the renderer is selected from the multiple pre-trained renderers as the current renderer; the current image is input to the current renderer, and the enhanced image of the current image in the dimension corresponding to the current renderer is output through the current renderer; and the preceding operation is repeated by configuring the enhanced image of the current image in the dimension corresponding to the current renderer as the current image until the current image does not satisfy the enhancement condition. That is, according to the present application, the renderer can be adaptively selected from the multiple renderers, and with the renderer, the current image is rendered in the dimension corresponding to the renderer. With existing image enhancement methods such as a manual adjustment by a colorist in a later stage or some algorithms, the image can be enhanced only in a respective dimension and cannot be processed in multiple dimensions. According to the technical means of the present application, the multiple renderers are trained in advance and the current image is enhanced through the multiple renderers one by one. Therefore, the technical problems are overcome that in the related art, manually adjusting colors is time-consuming and labor-intensive, the results of the adjustment are limited by the level of the colorist, and it is very difficult to quickly adjust the colors in large batches and obtain satisfactory results; and it is very difficult for existing algorithms to perform an adaptive adjustment in the multiple dimensions on a large scale, and the existing algorithms are only adaptable to a particular scenario. With the technical solution provided by the present application, the image can be adaptively enhanced in the multiple dimensions on a large scale, which is time-saving and labor-saving, strongly effective, and applicable to the various application scenarios. Moreover, the technical solution of the embodiment of the present application is simple and convenient to implement, easy to popularize, and applicable to a wider range.

### Embodiment Four

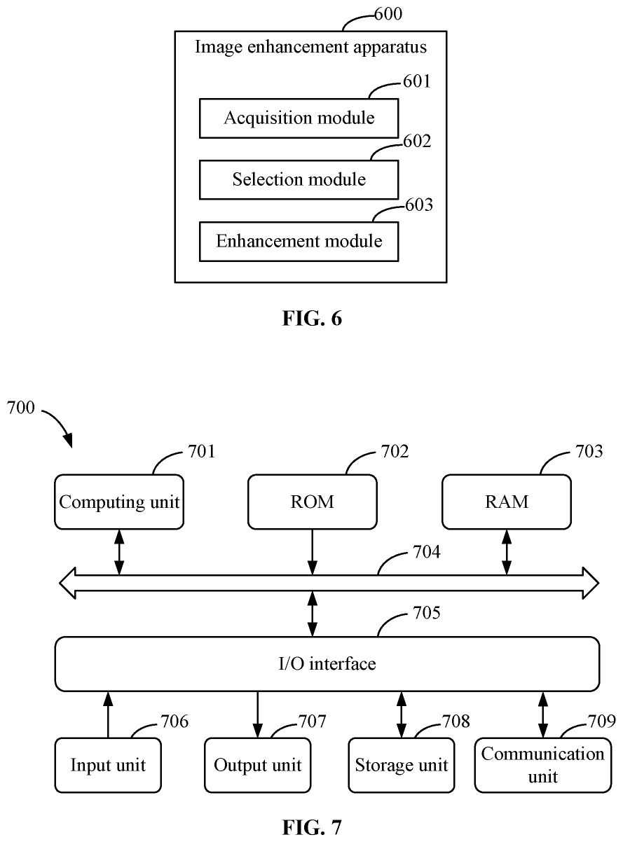

FIG. 6 is a structural diagram of an image enhancement apparatus according to an embodiment of the present application. As shown in FIG. 6, the apparatus 600 includes an acquisition module 601, a selection module 602, and an enhancement module 603.

The acquisition module 601 is configured to acquire an original image and configure the original image as a current image.

The selection module 602 is configured to select a renderer from multiple pre-trained renderers as a current renderer in a case where the current image satisfies a preset enhancement condition.

The enhancement module 603 is configured to: input the current image to the current renderer and output, through the current renderer, an enhanced image of the current image in a dimension corresponding to the current renderer; and repeat the preceding operation by configuring the enhanced image of the current image in the dimension corresponding to the current renderer as the current image until the current image does not satisfy the enhancement condition.

Further, the enhancement module 603 is configured to: input the current image to a first network and a second network in the current renderer; obtain, based on the current image through the first network, a rendering value corresponding to the current image in the current renderer; and transmit the rendering value to the second network and render the current image based on the rendering value through the second network so that the enhanced image of the current image in the dimension corresponding to the current renderer is obtained.

Further, the enhancement module 603 is configured to: input the current image to a CNN and perform feature extraction on the current image through the CNN so that a feature map corresponding to the current image is obtained; calculate a mean, a variance, and a maximum value of the feature map on each path; and predict, based on the mean, the variance, and the maximum value of the feature map on each path, the rendering value corresponding to the current image in the current renderer.

Further, the enhancement module 603 is configured to: downsample the current image so that a downsampled image is obtained; and perform, by configuring the downsampled image as the current image, the operation of inputting the current image to the CNN.

Further, the enhancement module 603 is configured to: input the current image to a first rendering unit in the second network so that a rendering result output by the first rendering unit is obtained; and input the rendering result output by the first rendering unit and the rendering value to a second rendering unit in the second network so that a rendering result output by the second rendering unit is obtained and configure the rendering result output by the second rendering unit as the enhanced image of the current image in the dimension corresponding to the current renderer; where the first rendering unit includes two fully connected layers and one activation function; and the second rendering unit includes two fully connected layers and two activation functions.

Further, the apparatus further includes a training module 604 (not shown in the figure) that is configured to: extract, in a case where any render among the multiple renderers does not satisfy a convergence condition corresponding to the render, an image from an image library corresponding to the renderer as the current image; and train the renderer configuring the current image until the renderer satisfies the convergence condition.

The preceding image enhancement apparatus can execute the method provided by any embodiment of the present application and has functional modules and beneficial effects corresponding to the executed method. For technical details not described in detail in the embodiment, reference may be made to the image enhancement method provided by any embodiment of the present application.

### Embodiment Five

According to an embodiment of the present disclosure, the present disclosure also provides an electronic device, a readable storage medium, and a computer program product.

FIG. 7 is a block diagram of an example electronic device 700 that may be configured to implement an embodiment of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 7, the device 700 includes a computing unit 701. The computing unit 702 may perform various appropriate actions and processing according to a computer program stored in a read-only memory (ROM) 702 or a computer program loaded into a random-access memory (RAM) 703 from a storage unit 708. Various programs and data required for the operation of the device 700 may also be stored in the RAM 703. The computing unit 701, the ROM 702, and the RAM 703 are connected to each other through a bus 704. An input/output (I/O) interface 705 is also connected to the bus 704.

Multiple components in the device 700 are connected to the I/O interface 705. The multiple components include an input unit 706 such as a keyboard or a mouse, an output unit 707 such as various types of displays or speakers, the storage unit 708 such as a magnetic disk or an optical disc, and a communication unit 709 such as a network card, a modem or a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Examples of the computing unit 701 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 701 performs various preceding methods and processing, such as the image enhancement method. For example, in some embodiments, the image enhancement method may be implemented as computer software programs tangibly contained in a machine-readable medium such as the storage unit 708. In some embodiments, part or all of computer programs may be loaded and/or installed on the device 700 via the ROM 702 and/or the communication unit 709. When the computer program is loaded to the RAM 703 and executed by the computing unit 701, one or more steps of the preceding image enhancement method may be performed. Alternatively, in other embodiments, the computing unit 701 may be configured, in any other appropriate manner (for example, by means of firmware), to perform the image enhancement method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is configured by or in conjunction with a system, apparatus, or device that executes instructions. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. The clients and the servers are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

It is to be understood that various forms of the preceding flows may be used, with steps reordered, added, or removed. For example, the steps described in the present disclosure may be executed in parallel, in sequence, or in a different order as long as the desired result of the technical solution provided in the present application is achieved. The execution sequence of these steps is not limited herein. Operations, including acquisition, storage, and application, on a user's personal information involved in the technical solution of the present disclosure conform to relevant laws and regulations and do not violate the public policy doctrine.

The scope of the present disclosure is not limited to the preceding embodiments. It is to be understood by those skilled in the art that various modifications, combinations, subcombinations, and substitutions may be made depending on design requirements and other factors. Any modification, equivalent substitution, improvement, and the like made within the spirit and principle of the present disclosure are within the scope of the present disclosure.

What is claimed is:

1. An image enhancement method, comprising:
acquiring an original image, and configuring the original image as a current image;
selecting a renderer from a plurality of pre-trained renderers as a current renderer in response to the current image satisfying a preset enhancement condition; and
inputting the current image to the current renderer, and outputting, through the current renderer, an enhanced image of the current image in a dimension corresponding to the current renderer; and repeating the preceding operation by configuring the enhanced image of the current image in the dimension corresponding to the current renderer as the current image until the current image does not satisfy the enhancement condition.

2. The method according to claim 1, wherein inputting the current image to the current renderer, and outputting, through the current renderer, the enhanced image of the current image in the dimension corresponding to the current renderer comprises:
inputting the current image to a first network and a second network in the current renderer; and obtaining, based on the current image through the first network, a rendering value corresponding to the current image in the current renderer; and
transmitting the rendering value to the second network, and rendering the current image based on the rendering value through the second network to obtain the enhanced image of the current image in the dimension corresponding to the current renderer.

3. The method according to claim 2, wherein the obtaining, based on the current image through the first network, the rendering value corresponding to the current image in the current renderer comprises:
inputting the current image to a convolutional neural network (CNN), and performing feature extraction on the current image through the CNN to obtain a feature map corresponding to the current image;
calculating a mean, a variance, and a maximum value of the feature map on each path; and
predicting, based on the mean, the variance, and the maximum value of the feature map on each path, the rendering value corresponding to the current image in the current renderer.

4. The method according to claim 3, wherein before inputting the current image to the CNN, the method further comprises:
downsampling the current image to obtain a downsampled image; and performing, by configuring the downsampled image as the current image, the operation of inputting the current image to the CNN.

5. The method according to claim 2, wherein the rendering the current image based on the rendering value through the second network to obtain the enhanced image of the current image in the dimension corresponding to the current renderer comprises:
inputting the current image to a first rendering unit in the second network to obtain a rendering result output by the first rendering unit; and
inputting the rendering result output by the first rendering unit and the rendering value to a second rendering unit in the second network to obtain a rendering result output by the second rendering unit, and configuring the rendering result output by the second rendering unit as the enhanced image of the current image in the dimension corresponding to the current renderer; wherein the first rendering unit comprises two fully connected layers and one activation function, and the second rendering unit comprises two fully connected layers and two activation functions.

6. The method according to claim 1, further comprising:
in response to any render among the plurality of pre-trained renderers not satisfying a convergence condition corresponding to the any render, extracting an image from an image library corresponding to the any renderer as the current image; and training the any renderer configuring the current image until the any renderer satisfies the convergence condition.

7. An electronic device, comprising:
at least one processor; and
a memory communicatively connected to the at least one processor;
wherein the memory stores instructions executable by the at least one processor, and the instructions are executed by the at least one processor to cause the at least one processor to perform an image enhancement method, wherein the method comprises:
acquiring an original image, and configuring the original image as a current image;
selecting a renderer from a plurality of pre-trained renderers as a current renderer in response to the current image satisfying a preset enhancement condition; and
inputting the current image to the current renderer, and outputting, through the current renderer, an enhanced image of the current image in a dimension corresponding to the current renderer; and repeating the preceding operation by configuring the enhanced image of the current image in the dimension corresponding to the current renderer as the current image until the current image does not satisfy the enhancement condition.

8. The electronic device according to claim 7, wherein inputting the current image to the current renderer, and outputting, through the current renderer, the enhanced image of the current image in the dimension corresponding to the current renderer comprises:
inputting the current image to a first network and a second network in the current renderer; and obtaining, based on the current image through the first network, a rendering value corresponding to the current image in the current renderer; and
transmitting the rendering value to the second network, and rendering the current image based on the rendering value through the second network to obtain the enhanced image of the current image in the dimension corresponding to the current renderer.

9. The electronic device according to claim 8, wherein the obtaining, based on the current image through the first network, the rendering value corresponding to the current image in the current renderer comprises:
inputting the current image to a convolutional neural network (CNN), and performing feature extraction on the current image through the CNN to obtain a feature map corresponding to the current image;
calculating a mean, a variance, and a maximum value of the feature map on each path; and
predicting, based on the mean, the variance, and the maximum value of the feature map on each path, the rendering value corresponding to the current image in the current renderer.

10. The electronic device according to claim 9, wherein before inputting the current image to the CNN, the method further comprises:
downsampling the current image to obtain a downsampled image; and performing, by configuring the downsampled image as the current image, the operation of inputting the current image to the CNN.

11. The electronic device according to claim 8, wherein the rendering the current image based on the rendering value through the second network to obtain the enhanced image of the current image in the dimension corresponding to the current renderer comprises:
inputting the current image to a first rendering unit in the second network to obtain a rendering result output by the first rendering unit; and
inputting the rendering result output by the first rendering unit and the rendering value to a second rendering unit in the second network to obtain a rendering result output by the second rendering unit, and configuring the rendering result output by the second rendering unit as the enhanced image of the current image in the dimension corresponding to the current renderer;
wherein the first rendering unit comprises two fully connected layers and one activation function, and the second rendering unit comprises two fully connected layers and two activation functions.

12. The electronic device according to claim 7, further comprising:
in response to any render among the plurality of pre-trained renderers not satisfying a convergence condition corresponding to the any render, extracting an image from an image library corresponding to the any renderer as the current image; and training the any renderer configuring the current image until the any renderer satisfies the convergence condition.

13. A non-transitory computer-readable storage medium storing computer instructions for causing a computer to perform an image enhancement method, wherein the method comprises:
acquiring an original image, and configuring the original image as a current image;
selecting a renderer from a plurality of pre-trained renderers as a current renderer in response to the current image satisfying a preset enhancement condition; and
inputting the current image to the current renderer, and outputting, through the current renderer, an enhanced image of the current image in a dimension corresponding to the current renderer; and repeating the preceding operation by configuring the enhanced image of the current image in the dimension corresponding to the current renderer as the current image until the current image does not satisfy the enhancement condition.
